(19) United States
(12) Patent Application Publication
(10) Pub. No.: US 2023/0080940 A1
(43) Pub. Date: Mar. 16, 2023

(54) Hair Brush

(71) Applicant: DONGGUAN KINSON VACUUM TECHNOLOGY CO., LTD., Dongguan (CN)

(72) Inventor: Jiacai Xu, Dongguan (CN)

(21) Appl. No.: 17/540,415

(22) Filed: Dec. 2, 2021

(30) Foreign Application Priority Data
Sep. 16, 2021 (CN) 202111089428.4
Nov. 22, 2021 (CN) 202111382813.8

(51) Int. Cl. A46B 15/00; A45D 24/10

(52) U.S. Cl. CPC A46B 15/002; A45D 24/10; A45D 2024/002

(57) ABSTRACT

The disclosure provides a hair brush, comprising a body, a comb teeth assembly and an active static electricity elimination device; the body is provided with a hollow cavity; the comb teeth assembly comprises a plurality of comb teeth which is provided on the body; the active static electricity elimination device is set in the hollow cavity; the active static electricity elimination device comprises a static electricity processing device and a plurality of additional function devices; the input end of the static electricity processing device is electrically connected with the comb teeth assembly, the output end of the static electricity processing device is electrically connected with at least one of the pluralities of additional function devices, and the static electricity processing device processes the static electricity input by the comb teeth assembly and outputs the static electricity to the additional function devices, which consumes electric energy of the processed static electricity.

### CROSS-REFERENCE TO RELATED APPLICATION

This application claims the priority of Chinese Patent Application No. 202111089428. 4 filed on Sep. 16, 2021 and Chinese Patent Application No. 202111382813.8 filed on Nov. 22, 2021, the disclosures of which are incorporated herein by reference.

### TECHNICAL FIELD

The disclosure relates to the field of articles for daily use, in particular to a hair brush, and more particularly relates to a hair brush for eliminating static electricity.

### BACKGROUND

At present, the plastic hair brush on the market mainly uses a passive static electricity elimination mode in an anti-static processing procedure, namely, static electricity has to be eliminated in a mode of leading the static electricity into the ground after passing through the hair brush and a human body.

In practical applications, it is found that in a dry environment in winter, the human body impedance is increased, so that static electricity cannot be completely dissipated, and in addition, the human body is insulated from the ground because of shoes, and static electricity cannot be completely introduced into the ground.

### Summary of Disclosure

In order to guarantee the validity of static dissipation under multiple environments, the disclosure provides a hair brush, which provides active static eliminator to dissipate and the convert static electricity, and then provide the static electricity to additional function device for use, so it can also the reutilize the static electricity when eliminating static electricity so as to guarantee the static dissipation effect of the hair brush.

Correspondingly, the present disclosure provides a hair brush, which comprises a body, a comb teeth assembly and an active static electricity elimination device;

the body is provided with a hollow cavity;

the comb teeth assembly comprises a plurality of comb teeth and the comb teeth assembly is provided on the body;

the active static electricity elimination device is set in the hollow cavity;

the active static electricity elimination device comprises a static electricity processing device and a plurality of additional function devices;

the input end of the static electricity processing device is electrically connected with the comb teeth assembly, the output end of the static electricity processing device is electrically connected with at least one of the pluralities of additional function devices, and the static electricity processing device processes the static electricity input by the comb teeth assembly and outputs the processed static electricity to the additional function devices;

and the additional function devices consumes electric energy of the processed static electricity.

In some embodiments, the static electricity processing device comprises a static electricity conversion module, an input end of the static electricity conversion module is electrically connected with the comb teeth assembly, an output end of the static electricity conversion module is electrically connected with the at least one additional function device, and the static electricity conversion module converts the static electricity and outputs the processed static electricity to the additional function device.

In some embodiments, the static electricity conversion module comprises a high voltage suppression unit and a voltage stabilization output unit, an input end of the high voltage suppression unit is electrically connected with the comb teeth assembly, an output end of the high voltage suppression unit is electrically connected with an input end of the voltage stabilization output unit, and an output end of the voltage stabilization output unit is electrically connected with the additional function device;

the high voltage suppression unit performs voltage suppression on the instantaneous high voltage of the static electricity input by the comb teeth assembly and then outputs the static electricity to the voltage stabilization output unit, and the voltage stabilization output unit performs voltage stabilization on the static electricity after voltage suppression and then inputs the static electricity to the additional function device.

In some embodiments, the static electricity processing device further comprises a static electricity storage module, an input end of the static electricity storage module is connected with an output end of the static electricity conversion module, an output end of the static electricity storage module is electrically connected with at least one additional function device, the static electricity conversion module converts the static electricity and outputs the processed static electricity to the static electricity storage module, and the static electricity storage module stores the processed static electricity and outputs the stored static electricity to the additional function device.

In some embodiments, one of the pluralities of additional function devices is a light-emitting device, an input end of the light-emitting device is electrically connected with an output end of the static electricity processing device, and the light-emitting device converts the electric energy of the processed static electricity into light energy and then consumes the light energy.

In some embodiments, the light-emitting device comprises a light-emitting controller and a light-emitting source, the light-emitting controller and the light-emitting source being provided in the hollow cavity, the light-emitting source being controlled based on the light-emitting controller;

the light-emitting light source is electrically connected with the output end of the static electricity processing device, and the light-emitting light source converts the electric energy of the processed static electricity into light energy and then consumes the light energy;

at least one comb tooth of the plurality of comb teeth is made of a first light-transmitting material and is communicated into the inner cavity of the body, and/or the body is made of a second light-transmitting material.

In some embodiments, the first light-transmitting material is a transparent material containing a light diffusing agent.

In some embodiments, the volume ratio of the light diffusing agent in the transparent material is 0.5 to 1%.

In some embodiments, the transparent material is also mixed with a light anti-reflection agent.

In some embodiments, the volume ratio of the light anti-reflection agent in the transparent material is 2.5 to 3.5%.

In some embodiments, the surface of the body is further provided with a pattern layer provided that the material of the body is a second light-transmitting material.

In some embodiments, at least part of the cavity wall of the body are covered with a light reflecting film.

In some embodiments, the light-emitting device further comprises a light-emitting control button exposed on the surface of the body;

the light-emitting control button is electrically connected with the light-emitting controller.

In some embodiments, the light-emitting device further comprises a sound acquisition element, the light-emitting controller is a sound-controlled controller;

the sound-control controller is electrically connected with the sound acquisition element.

In some embodiments, one of the pluralities of additional function devices is a temperature sensing device, an input end of the temperature sensing device is electrically connected with an output end of the static electricity processing device, and an electrical element in the temperature sensing device consumes electric energy of the processed static electricity.

In some embodiments, one of the pluralities of additional function devices is a humidity sensing device, an input end of the humidity sensing device is electrically connected with an output end of the static electricity processing device, and an electrical element in the humidity sensing device consumes electric energy of the processed static electricity.

In some embodiments, one of the pluralities of additional function devices is a vibration device, an input end of the vibration device is electrically connected with an output end of the static electricity processing device, and an electrical element in the vibration device consumes electric energy of the processed static electricity.

In some embodiments, one of the pluralities of additional function devices is a multi-parameter skin test device, an input end of the multi-parameter skin test device is electrically connected with an output end of the static electricity processing device, and an electrical element in the multi-parameter skin test device consumes electric energy of the processed static electricity.

In some embodiments, the hair brush further comprises a display screen, and at least one additional function device in the pluralities of additional function devices is electrically connected with the display screen so as to display the contents required to be displayed by the additional function device through the display screen.

In some embodiments, the teeth are made of a flexible conductive material.

In some embodiments, the comb teeth assembly further comprises a rubber sheet, and the pluralities of comb teeth are provided on the rubber sheet;

one end of the body is an open end, the rubber sheet is wrapped on the edge of the open end of the body and closes the open end, the hollow cavity is formed by the rubber sheet wrapping around the edge of the open end of the body, or the body is of a cylindrical structure, the hollow cavity is provided in the body, and at least part of the rubber sheet is wrapped on the side surface of the inner part of the body;

the rubber sheet is made of a flexible material, and when the hair brush is in a stowed mode, the rubber sheet is sunken into the hollow cavity, so that a notch is formed between the rubber sheet and the open end to accommodate all the comb teeth and prevent the end of the comb teeth which is far away from the rubber sheet from extending out of the open end; when the hair brush is in a deployed mode, the rubber sheet bulges outwards from the open end, so that the rubber sheet and the comb teeth are completely exposed outside the open end of the body.

In some embodiments, the body comprises an upper housing and a lower housing, one end of the lower housing is the open end of the body, the other end of the lower housing is detachably connected with one end of the upper housing, the other end of the upper housing is provided with the top cover, the top cover moves up and down along the direction perpendicular to the edge of the upper housing so as to make the top cover contact rubber sheet and exert a force on the rubber sheet in order to push the sunken rubber sheet to bulges from the edge of the open end under exogenic action.

In some embodiments, the comb teeth assembly further comprises a rubber sheet, and the plurality of comb teeth are provided on the rubber sheet;

the body comprises a hand holder and a head handle, and the hollow cavity comprises a head handle inner cavity provided at the side of the head handle and a hand holder inner cavity provided at the side of the hand holder; one end of the head handle is an open end, the rubber sheet is wrapped on the edge of the open end of the head handle and closes the open end, and the head handle inner cavity is provided between the head handle and the rubber sheet; or the head handle is of a cylindrical structure, the head handle inner cavity is provided in the head handle, and at least part of the rubber sheet is wrapped on the inner side surface of the head handle.

In some embodiments, the hand holder and the head handle are separated structures from each other, and the hand holder and the head handle are connected through a connecting structure.

In some embodiments, the rubber sheet is made of a flexible conductor material.

In some embodiments, the hair brush further comprises a counter-weight module;

the counter-weight module is provided at the end of the body which is far away from the comb teeth assembly.

In summary, the present disclosure provides a hair brush, which is provided with an active static electricity elimination device, and compared to a passive static electricity elimination device, the hair brush has a wider application range, and has good practicability; the active static electricity elimination device may collect static electricity and provide the static electricity to an additional function device to consume the electric energy, but not directly dissipate the static electricity, so that it may fully utilize the energy, avoid wasting the energy and realize internal supply of the energy; and by providing various additional function devices, the hair brush may illuminate structures such as comb teeth, monitor the temperature and humidity around the comb teeth, and drive the comb teeth to vibrate in a vibration transmission mode, so that it can better meet the use requirements of users; in addition, by providing the auxiliary power supply device, the hair brush can ensure the use of the additional function device under the condition of no static electricity supply, and the additional function device in the hair brush can be ensured to work stably.

### BRIEF DESCRIPTION OF DRAWINGS

In order to more clearly illustrate the embodiments of the present disclosure or the technical solutions in the prior art, the drawings used in the embodiments or the description of the prior art will be briefly described below, it is obvious that the drawings in the following description are only some embodiments of the present disclosure, and other drawings can be obtained by those skilled in the art without creative efforts.

FIG. 1 is an exploded schematic view of a hair brush according to an embodiment of the present disclosure;

FIG. 2 is a schematic view of the hair brush of FIG. 1 in a stowed mode according to an embodiment of the disclosure;

FIG. 3 is a three-dimensional structure schematic diagram of a hair brush according to an embodiment of the disclosure;

FIG. 4 is a schematic diagram of an exploded structure of a hair brush according to an embodiment of the present disclosure;

FIG. 5 is a three-dimensional structure schematic diagram of a hand holder of a curling hair brush according to an embodiment of the present disclosure;

FIG. 6 is a schematic circuit diagram of an active static electricity elimination device according to an embodiment of the present disclosure;

FIG. 7 is a schematic circuit diagram of an active static electricity elimination device according to an embodiment of the present disclosure;

FIG. 8 is a schematic circuit diagram of an additional function device according to an embodiment of the disclosure;

FIG. 9 is a schematic circuit diagram of a light-emitting device according to an embodiment of the disclosure;

FIG. 10 is a schematic circuit diagram of a temperature sensing device according to an embodiment of the disclosure;

FIG. 11 is a schematic circuit diagram of a humidity sensing device according to an embodiment of the disclosure;

FIG. 12 is a schematic circuit diagram of a multi-parameter skin test device according to an embodiment of the disclosure;

FIG. 13 is a schematic circuit diagram of a multi-parameter skin test device according to an embodiment of the present disclosure.

Wherein, 1. comb teeth; 100. hand holder; 101. comb teeth assembly; 2. rubber sheet; 3. vibration mounting; 4. vibration device; 5. light-emitting source; 6. head handle; 7. middle ring; 8. display hole; 9. vibration control hole; 10. light emission control hole; 11. sound source input hole; 12. hand holder front cover; 13. vibration control button; 14. light-emitting control button; 15. sound acquisition element; 16. buzzer; 17. charge indicator light; 18. charging port; 19. PCB board; 20. display screen; 22. electric storage battery pressing block; 23. electric storage module; 24. hand holder rear cover; 25. open end; 26. upper housing; 27. lower housing; 28. top cover.

### DETAILED DESCRIPTION

The technical solutions in the embodiments of the present disclosure will be described clearly and completely with reference to the drawings in the embodiments of the present disclosure, and it is obvious that the embodiments described are only some embodiments of the present disclosure, rather than all embodiments. All other embodiments, which can be derived by a person skilled in the art from the embodiments disclosed herein without making any creative effort, shall fall within the protection scope of the present disclosure.

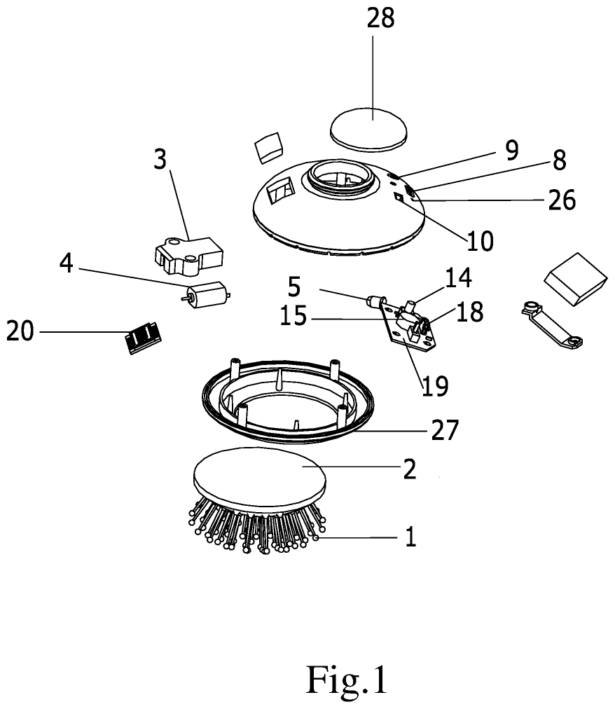

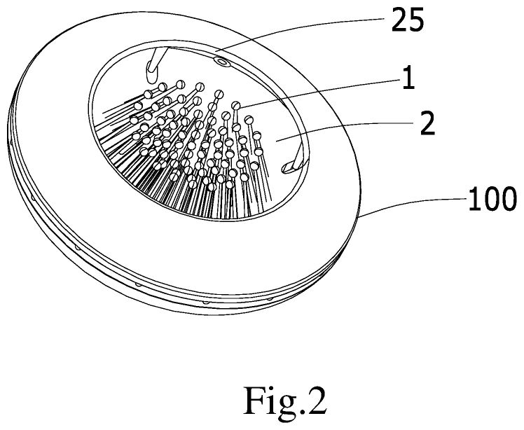

FIG. 1 is an exploded schematic view of a hair brush according to an embodiment of the present disclosure; FIG. 2 is a schematic view of the hair brush of FIG. 1 in a stowed mode according to an embodiment of the disclosure; as shown in FIG. 1, the hair brush comprises a body 100, a comb teeth assembly 101, and an active static electricity elimination device; the body 100 is a structure for fixing and supporting the hair brush, the body 100 has a hollow cavity in order to accommodate an active static electricity elimination device and a plurality of additional function devices, the comb teeth assembly 101 is a component structure associated with the comb teeth 1, the active static electricity elimination device is a device for converting static electricity generated by the hair into power, and the plurality of additional function devices are functional components for consuming electric quantity of the active static electricity elimination device.

As shown in FIG. 1, the hair brush comprises a body 100 and a comb teeth assembly 101; the body 100 has a hollow cavity, which may be used to accommodate various components; the comb teeth assembly 101 comprises a plurality of comb teeth 1, and the comb teeth assembly 101 is provided on the body 100; the comb teeth assembly 101 comprises a rubber sheet 2, and a plurality of comb teeth 1 are provided on the rubber sheet 2; one end of the body 100 is an open end 25, the rubber sheet 2 wraps the edge of the open end 25 of the body 100 and closes the open end 25, and a hollow cavity is provided between the body 100 and the rubber sheet 2, specifically, the hollow cavity is formed by the body 100 and the rubber sheet 2, more specifically, the body 100 is a hollow structure and the hollow cavity is formed by the rubber sheet 2 wrapping the open end 25 of the body 100 and the outer edge of the body 100, or the body 100 is a cylindrical structure, the hollow cavity is provided in the body 100, and at least part of the rubber sheet 2 wraps the inner side surface of the body 100; the rubber sheet 2 is made of a flexible material, and when the hair brush is in a stowed mode, the rubber sheet 2 is sunken into the hollow cavity, so that a notch is formed between the rubber sheet 2 and the open end 25 to accommodate all the comb teeth 1 and prevent the end, which is far away from the rubber sheet 2, of each comb tooth 1 from extending out of the open end 25; when in the deployed mode, the rubber sheet 2 bulges outward from the open end 25 so that the rubber sheet 2 and the comb teeth 1 are completely exposed outside the body 100. One end of comb teeth 1 at which comb teeth 1 and rubber sheet 2 connected with each other is the head end, and the other end of the comb teeth 1 which kept away from the rubber sheet 2 is the tail end, and when hair brush is in the stowed mode, as shown in FIG. 2, all the comb teeth 1 overall structure are all accommodated in the notch that rubber sheet 2 and open the end 25 forms, or the tail end of comb teeth 1, i.e. the one end of comb teeth 1 which is far away from rubber sheet 1 promptly reaches the edge of the opening the end 25. All the above are optimal technical schemes. However, a partial structure of the comb teeth 1, for example, the tail end of the comb teeth 1 slightly protrudes from the edge of the open end 25, should also be within the protection scope of the present disclosure. When the hair brush is in use, the rubber sheet 2 protrudes outward from the edge of the open end 25, i.e. both the head end and the tail end of the comb teeth 1 are completely exposed outside the open end 25 of the body 100.

As shown in FIG. 1, the body 100 comprises an upper housing 26 and a lower housing 27, one end of the lower housing 27 is an open end 25, the other end of the lower housing 27 is detachably connected with one end of the upper housing 26, the detachable connection comprises screwing locking, snap-fit connection, and the like. the other end of the upper housing 26 is provided with a top cover 28, and the top cover 28 moves up and down in a direction perpendicular to the upper housing 26 under the action of external force so that the top cover 28 contacts the rubber sheet 2 and exerts an acting force on the rubber sheet 2 to push the sunken rubber sheet 2 to protrude toward the open end 25. In this embodiment, the upper cover 26 and the lower cover 27 are detachably connected to facilitate the replacement of various patterns and components, and so as to realize the change of various colors and patterns. In this embodiment, the rubber sheet 2 is designed as an one-piece, during specific application, when the hair brush needs to be stowed, exert a acting force on the comb teeth 1, for example press the comb teeth 1 with the palm, or the comb teeth 1 of hair brush is pressed to desktop etc., and because rubber sheet 2 is made of a flexible material that can be extensile, exogenic action passes from the tail end of comb teeth 1 to the head end of comb teeth 1, rubber sheet 2 moves towards the cavity under the exogenic action so that rubber sheet 2 and the edge of opening end 25 forms a notch that holds all the comb teeth 1, and all the comb teeth 1 is all accommodated in the notch, as shown in FIG. 2. When in use, the top cover 28 is set to do reciprocating motion or elastic scaling motion along the direction of perpendicular to upper housing 26 under the exogenic action, which makes the top cover 28 directly contacts the rubber sheet 2 and exerts the acting force to the rubber sheet 2, because the rubber sheet 2 is made of flexible extensible material, the rubber sheet 2 is sunken to the open the end 25 and bulges outwards from interior cavity under the exogenic action of top cover 28, the whole rubber sheet 2 moves in lockstep under the exogenic action and makes the rubber sheet 2 drives the whole comb teeth assembly 101 bulges from the sunken notch to the open the end 25, until the comb teeth 1 all expose outside the open end 25 of the body 100. In this embodiment, the top cover 28 is preferably made of a transparent material, and is provided on the upper housing 26 through an elastic structure, so that the comb teeth 1 can return to the deployed mode from the stowed mode by an external force acting on the top cover 28 and then acting on the rubber sheet 2.

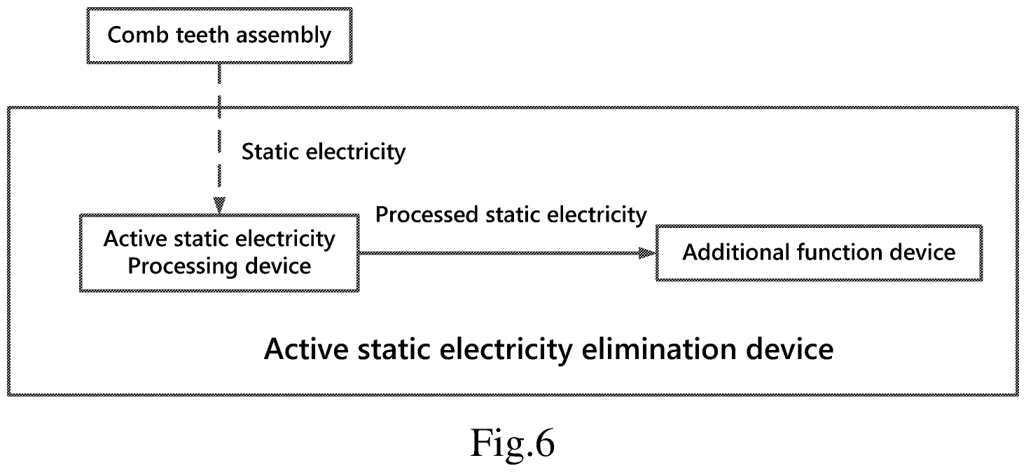

FIG. 6 is a schematic circuit diagram of an active static electricity elimination device according to an embodiment of the present disclosure. The active static electricity elimination device is a device for actively consuming static electricity, and eliminates static electricity without depending on a grounding method. In the embodiment of the present disclosure, unlike a passive static electricity elimination device, an active static electricity elimination device may achieve the purpose of static electricity elimination without depending on a grounding manner, and has a low requirement on static electricity elimination conditions in practical applications, and may achieve the purpose of static electricity elimination in more use occasions, thereby having good practicability.

Further, in order to achieve the purpose of static electricity elimination, the active static electricity elimination device according to the embodiment of the disclosure has to consume static electricity to perform the function of active static electricity elimination.

Specifically, as shown in FIG. 6, the active static electricity elimination device comprises a static electricity processing device and a plurality of additional function devices. The input end of the static electricity processing device is electrically connected with the comb teeth assembly 101 and can receive static electricity generated by the comb teeth assembly 101. The output end of the static electricity processing device is electrically connected with at least one additional function device of the pluralities of additional function devices. The static electricity processing device processes the static electricity input by the comb teeth assembly 101 and outputs the processed static electricity to the additional function device. The additional function device consumes electric energy of the processed static electricity. The static electricity processing device may be a static electricity conversion device, the additional function device can be a power consumption device, the static electricity processing device converts the static electricity into electric energy required by the additional function device, and the additional function device conducts power consumption processing on the electric energy, so as to utilize and consume the static electricity of the comb teeth assembly 101. Therefore, the active static electricity elimination device directly utilizes the additional function device to consume electric energy of the processed static electricity, so it may achieve the static electricity elimination purpose without depending on a grounding mode, and has smaller requirements on the static electricity elimination condition in practical applications. Also it may achieve the static electricity elimination purpose in more use occasions, and has good practicability.

In the embodiment of the present disclosure, there are two ways to implement the static electricity consumption of the active static electricity elimination device. Specifically, two specific modes of static electricity consumption are: the first static electricity consumption mode is that the static electricity collected from the static electricity input end is processed and then output from the consumption output end, which is directly used by the additional function device for consumption; the second static electricity consumption mode is that when the static electricity collected from the static electricity input end is processed and stored, the stored electric energy is output from the consumption output end according to the requirement of the additional function device.

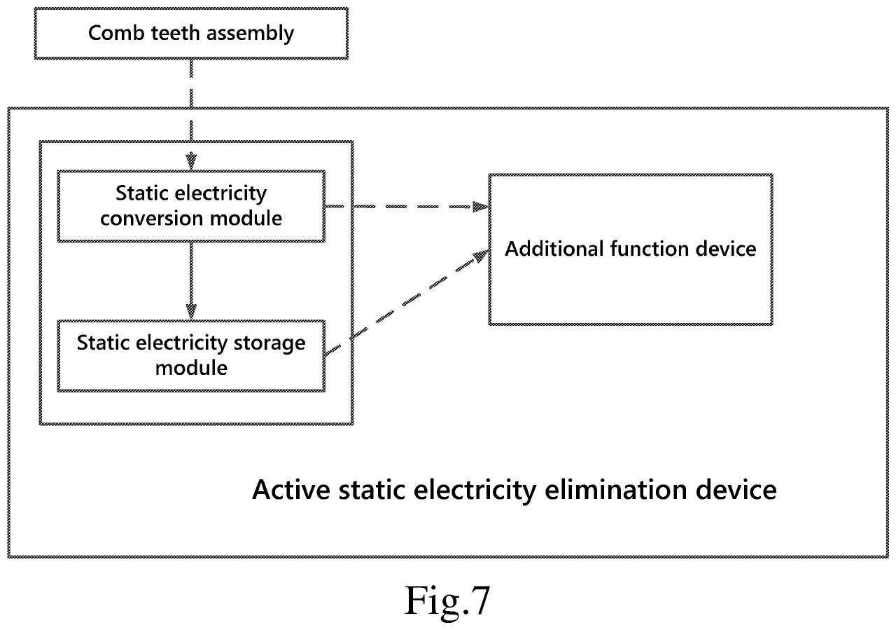

As shown in FIG. 7, in terms of the circuit configuration, in the first static electricity consumption mode, basically, the static electricity processing device comprises a static electricity conversion module. The input end of the static electricity conversion module is electrically connected with the comb teeth assembly 101, the output end of the static electricity conversion module is electrically connected with at least one additional function device, and the static electricity conversion module converts static electricity and outputs the processed static electricity to the additional function device. The static electricity conversion treatment may be the voltage reduction treatment of static electricity, the static electricity is converted into low-voltage static electricity, and then the low-voltage static electricity is output to an additional function device for power consumption. Or, the static electricity may be subjected to voltage stabilization treatment and converted into voltage stabilization static electricity, and then the voltage stabilization static electricity is output to the additional function device to perform power consumption.

In one embodiment, the static electricity conversion module comprises a high voltage suppression unit and a voltage stabilization output unit, wherein the input end of the high voltage suppression unit is electrically connected with the comb teeth assembly 101, the output end of the high voltage suppression unit is electrically connected with the input end of the voltage stabilization output unit, and the output end of the voltage stabilization output unit is electrically connected with the additional function device; the high voltage suppression unit performs voltage suppression on the instantaneous high voltage of the static electricity input by the comb teeth assembly 101 and then outputs the static electricity to the voltage stabilization output unit, and the voltage stabilization output unit performs voltage stabilization on the static electricity after voltage suppression and then inputs the static electricity to the additional function device.

Specifically, the static electricity conversion module mainly comprises a high voltage suppression unit and a voltage stabilization output unit, the high voltage suppression unit is a functional unit for suppressing the instantaneous high voltage of static electricity to a low voltage (for example, within 48V), and the high voltage suppression unit can be realized by using a high-capacity capacitor and the like. For example, the high voltage suppression unit may comprise a voltage reduction circuit, a voltage limitation circuit, and other structures, and if necessary, voltage suppression components such as an inductor and an isolation resistor may be added to the high voltage suppression unit according to actual requirements, so as to perform high voltage suppression on the voltage, and prevent the related circuit from being damaged by the instantaneous high voltage. The voltage stabilization output unit has to constantly output low-voltage electricity obtained by suppression in the high-voltage suppression unit, and the voltage stabilization output unit may be realized by a wide-width input voltage drop module and the like. The stable voltage obtained after passing through the voltage stabilization output unit can be used for static electricity storage and can also be directly output for driving of external equipment.

On this basis, as shown in FIG. 7, in the second static electricity consumption mode, the static electricity processing device further comprises an static electricity storage module; the input end of the static electricity storage module is connected with the output end of the static electricity conversion module, the output end of the static electricity storage module is electrically connected with at least one additional function device, the static electricity conversion module converts static electricity and outputs the processed static electricity to the static electricity storage module, and the static electricity storage module stores the processed static electricity and outputs the stored static electricity to the additional function device.

Specifically, as shown in FIG. 7, the manner of the static electricity conversion module performing the conversion processing on the static electricity may be described with reference to the first static electricity consumption mode. In the second static electricity consumption mode, after the static electricity converted and processed by the static electricity conversion module is stored, the stored electric energy is output to the additional function device according to the requirement of the additional function device, so that the additional function device can consume the electric energy.

The static electricity storage module can be various types of storage batteries so as to meet the condition of electric energy storage.

It should be noted that, in practical applications, after static electricity (energy) is generated, voltage (energy flow) can be generated only by flowing in a low energy direction, and therefore, in the design of the hair brush according to the embodiment of the present disclosure, if the input side of static electricity is used as a power supply positive electrode (i.e., the static electricity input end is used as a power supply positive electrode) for the internal circuit structure, a power supply negative electrode or a zero potential reference point may be selected as a body.

Specifically, the body 100 is generally made of an insulator, and in specific applications, a metal conductive layer is covered on the surface of the body to collect static electricity from hands (the metal conductive layer has to keep insulation with the comb teeth assembly 101), and then the metal conductive layer is used as a power supply cathode or a zero potential reference point; in specific applications, in the use process of the hair brush, static electricity can be generated due to friction between the comb teeth assembly 101 and hair, static electricity can be generated due to friction between the hand of a user and any object and falls on the metal conducting layer of the hand holder 6, and there is potential difference between the static electricity of the comb teeth assembly 101 and the static electricity of the hand holder 6 (the static electricity of the hand holder 6 is far smaller than the static electricity of the comb teeth assembly 101), so that an expected power supply loop is formed. Therefore, there is energy consumption in the power supply circuit, the power supply circuit can be operated without being grounded through a human body.

In this embodiment, the comb teeth 1 are made of a flexible conductor material, and the rubber sheet 2 is made of a flexible conductor material. The comb teeth assembly 101 is electrically connected with the active static electricity elimination device, static electricity generated by the comb teeth assembly 101 enters the static electricity elimination device, the output end of the static electricity processing device is electrically connected with at least one additional function device of the plurality of additional function devices, and the static electricity generated by hair is consumed through the additional function devices such as the light-emitting device, the temperature sensing device, the humidity sensing device, the vibration device and the multi-parameter skin test device.

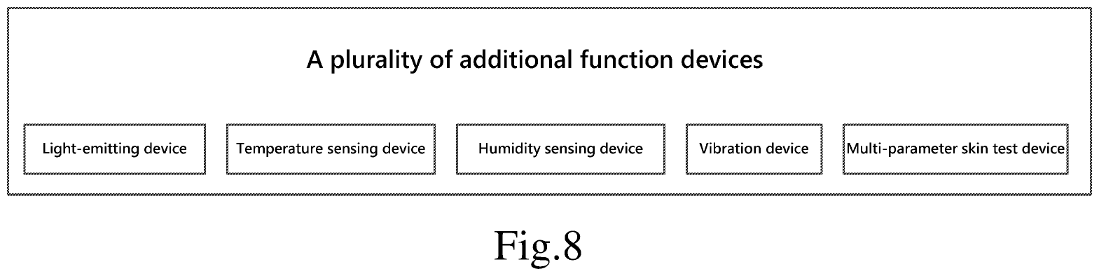

In the disclosed embodiment, as shown in FIG. 8, the several additional function devices comprise one or more of a light-emitting device, a temperature sensing device, a humidity sensing device, a vibration device, and a multi-parameter skin test device.

In one embodiment, one of the pluralities of additional function devices is a light-emitting device, an input end of the light-emitting device is electrically connected with an output end of the static electricity processing device, and the light-emitting device converts the processed static electricity electric energy into light energy and then consumes the light energy.

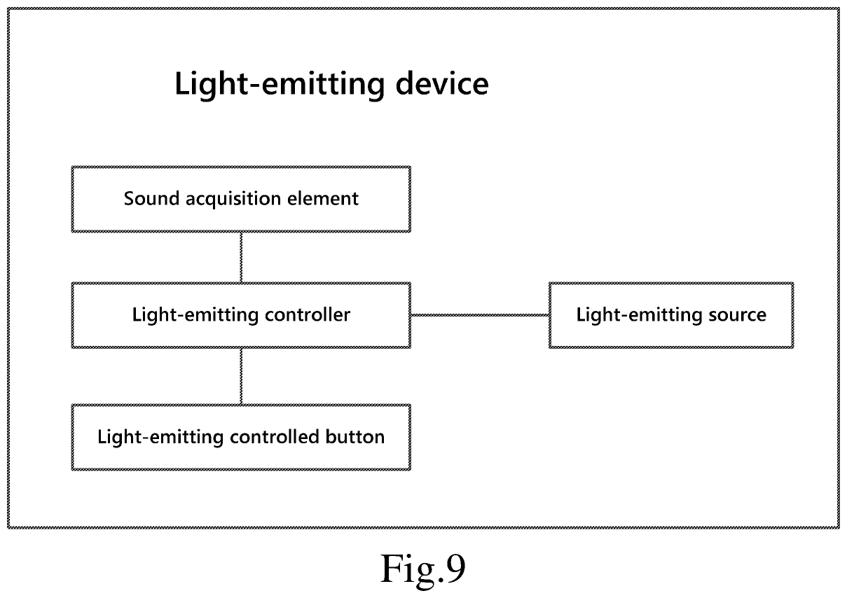

Specifically, as shown in FIG. 9, the light-emitting device comprises a light-emitting controller and a light-emitting source. The light-emitting controller may be electrically connected to an output end of the static electricity processing device, and the processed static electricity output by the static electricity processing device provides electric energy for the light-emitting controller. And/or the light-emitting light source is electrically connected with the output end of the static electricity processing device, and the light-emitting light source directly converts the electric energy of the processed static electricity output by the static electricity processing device into light energy. Both of these ways can consume static electricity. The light-emitting controller is provided in the hand holder inner cavity, the light-emitting light source is provided in the head handle inner cavity, and the control end of the light-emitting controller is used for controlling the light-emitting light source; at least one comb tooth 1 of the plurality of comb teeth 1 is made of a first light-transmitting material and is led into the head handle inner cavity, and/or the head handle 6 is made of a second light-transmitting material.

Specifically, light-emitting device can illuminate comb teeth 1 and/or head handle 6 to improve its sight, simultaneously, because light can be conducted from comb teeth 1 construction, which can illuminate the comparatively dark region of hair inside, so it will help the user to better observe the condition between the deep hair and has good practicality.

In addition, the light-emitting source can also use a RGB light-emitting source, through the control of luminous color to further improve the impression of user to the comb teeth 1. Specifically, the RGB light-emitting source can realize a color gradation effect. The light-emitting source can also be composed of a plurality of single-color light-emitting units, and the switching of colors is realized by lighting the light-emitting units with different colors.

Further, since the comb teeth 1 have a long strip-shaped structure, in order to ensure light conduction and visualization, in an alternative embodiment, the first light transmitting material is a transparent material containing a light diffusing agent. Specifically, the common light diffusing agent is titanium dioxide and other materials, and in an optional embodiment, the volume ratio of the light diffusing agent in the transparent material is 0.5% to 1%, so as to obtain a good appearance.

Further, in order to further improve the appearance, the transparent material is also mixed with a light anti-reflection agent. The volume ratio of the light antireflection agent in the transparent material is 2.5% to 3.5%.

Specifically, in order to further improve the appearance of the head handle 6 when the light-emitting device is turned on, a pattern layer is further provided on the surface of the head handle 6 under the condition that the material for manufacturing the head handle 6 is the second light-transmitting material. Specifically, the pattern layer is a layer of opaque or weakly transparent material covering the surface of the head handle 6, and patterns to be displayed are provided on the pattern layer; when the light-emitting device is on, a specific pattern required to be shown is displayed in a light and shade contrast mode or a mode of lighting different patterns by different colors, and the light-emitting device, which has better ornamental value.

Specifically, the display content of the pattern layer can be diversified, and by utilizing the light passing processing characteristics of the light-transmitting materials with different colors, the light-emitting device can lighten the patterns with corresponding colors by emitting light with different colors, so as to obtain more diversified display effects.

Furthermore, in order to ensure the transmission effect of light rays in the head handle inner cavity, a light reflecting film is covered on the cavity wall of the head handle inner cavity; in addition, the light reflecting film has to avoid the areas of the comb teeth 1 and the pattern area of the pattern layer, and the light may be continuously reflected in the head handle inner cavity until the light is led out of the areas of the comb teeth 1 or the pattern area of the pattern layer. The light of the light-emitting device will be better utilized in this way.

Further, regarding the control mode of the light-emitting device, optionally, as shown in FIG. 9, the light-emitting device further comprises a light-emitting control button 14, and the light-emitting control button 14 is provided on the surface of the hand holder 6; the light control button 14 is electrically connected to the light-emitting controller. By providing the physical button (the light-emitting control button 14), a user can conveniently control the light-emitting device when using the hair brush.

Further, the light-emitting device may also be controlled in a sound-control manner, specifically, as shown in FIG. 9, the light-emitting device further comprises a sound acquisition element 15, and the light-emitting controller is a sound-control controller; the signal input terminal of the sound-controlled controller is electrically connected to the sound acquisition device 15.

Specifically, the sound-controlled controller may execute corresponding light control operation according to the sound information, and may also realize the flicker and brightness control of the light according to the volume of the received sound, for example, the sound-controlled controller can control the light to beat along with music, so that the sound-controlled controller has good ornamental value. In particular, the implementation of the sound-controlled controller for controlling the light can be implemented by referring to the prior art.

In one embodiment, one of the pluralities of additional function devices is a temperature sensing device, an input end of the temperature sensing device is electrically connected with an output end of the static electricity processing device, and an electrical element in the temperature sensing device consumes electric energy of the processed static electricity.

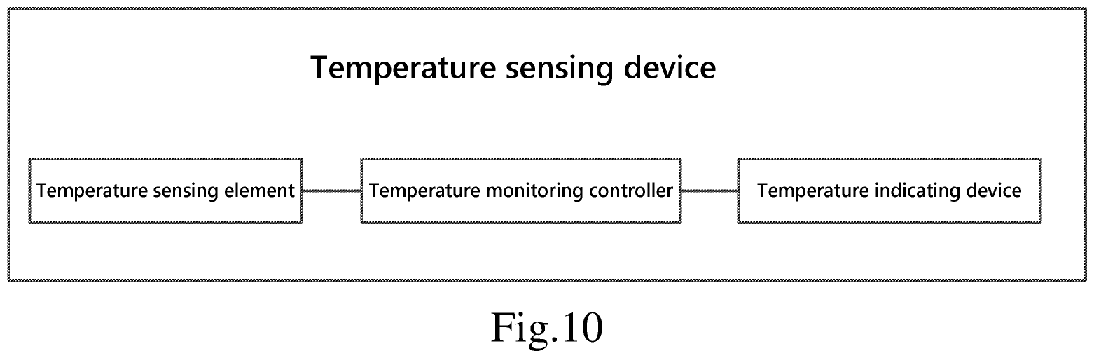

Specifically, as shown in FIG. 10, the temperature sensing device comprises a temperature sensing element, a temperature monitoring controller, and a temperature indicating device, and the temperature sensing element, the temperature monitoring controller, and the temperature indicating device are electrically connected in sequence. The electrical elements in the temperature sensing device comprise a temperature monitoring controller and a temperature indicating device. The temperature monitoring controller may be electrically connected to an output end of the static electricity processing device, and the processed static electricity output by the static electricity processing device provides electric energy for the temperature monitoring controller. And/or the temperature indicating device is electrically connected with the output end of the static electricity processing device, and the processed static electricity output by the static electricity processing device provides electric energy for the temperature indicating device. Both of these ways can consume static electricity. The temperature sensing element is integrated on the comb teeth 1, and the temperature monitoring controller and the temperature indicating device are provided in the hollow cavity; specifically, one of the usage scenarios of the hair brush is as follows: a user uses the air duct to blow hair, and a hair brush is needed for assistance; specifically, under this use scene, if the hair is dried by the air duct under long-time and concentrated, the stacked heat will make the temperature of the hair increased, which may damage the hair on the one hand, and may scald the human body on the other hand, consequently, through providing temperature sensing device in the hair brush, which can carry out real time monitoring to the temperature of hair, indicating the temperature through temperature indicating device, and preventing the emergence of above-mentioned condition. Specifically, the temperature indicating device may be a warning type device such as a buzzer 16, or may be a data display type device such as a display 20 or a sound announcer (speaker).

In one embodiment, one of the pluralities of additional function devices is a humidity sensing device, an input end of the humidity sensing device is electrically connected with an output end of the static electricity processing device, and an electrical element in the humidity sensing device consumes electric energy of the processed static electricity.

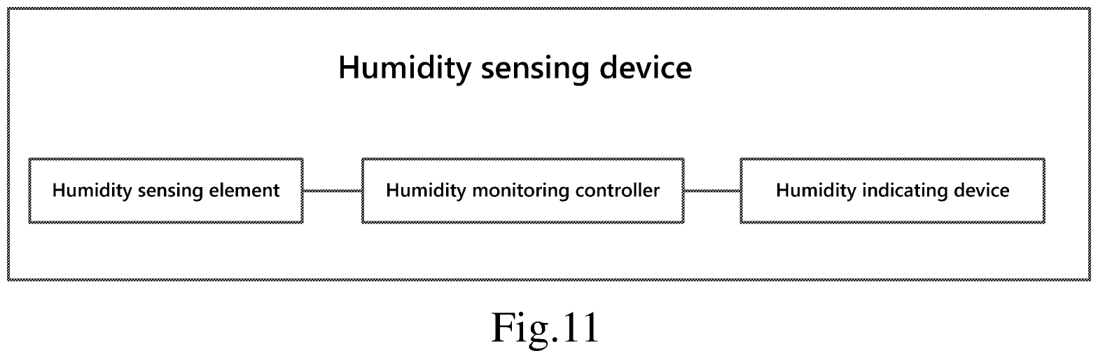

Furthermore, in order to facilitate the use of air duct, one of the pluralities of additional function devices is a humidity sensing device; specifically, as shown in FIG. 11, the humidity sensing device comprises a humidity sensing element, a humidity monitoring controller and a humidity indicating device; the humidity sensing element, the humidity monitoring controller and the humidity indicating device are electrically connected in sequence. The electrical elements in the humidity sensing device comprise a humidity monitoring controller and a humidity indicating device. The humidity monitoring controller may be electrically connected to an output end of the static electricity processing device, and the processed static electricity output by the static electricity processing device provides electric energy for the humidity monitoring controller. And/or the humidity indicating device is electrically connected with the output end of the static electricity processing device, and the processed static electricity output by the static electricity processing device provides electric energy for the humidity indicating device. Both of these ways can consume static electricity.

The humidity sensing element is integrated on the comb teeth 1, and the humidity monitoring controller and the humidity indicating device are provided in the hollow cavity; for a user with thicker hair, deep hair is difficult to be dried, and the user hardly accurately judges whether the hair weathers completely, consequently, through increasing humidity induction system, can judge whether the hair weathers through the acquirement of humidity to signal through humidity indicating device. Specifically, the humidity indicating device may be a warning type device such as a buzzer 16, or may be a data display type device such as a display 20 and a sound announcer (speaker).

In one embodiment, one of the pluralities of additional function devices is a vibration device, an input end of the vibration device is electrically connected with an output end of the static electricity processing device, and an electrical element in the vibration device consumes electric energy of the processed static electricity.

Specifically, the vibration device comprises a vibration element 4 and a vibration controller, and the vibration element 4 is electrically connected to the vibration controller. The electrical elements in the vibration device comprise a vibration controller and a vibration element. The vibration controller may be electrically connected to an output end of the static electricity processing device, and the processed static electricity output by the static electricity processing device provides electric energy for the vibration controller to consume the electric energy of the static electricity. And/or the vibration element 4 is electrically connected with the output end of the static electricity processing device, and the processed static electricity output by the static electricity processing device provides electric energy for the vibration element 4. Both of these ways can consume static electricity.

Wherein, the vibration element 4 is provided in the inner cavity of the head handle. The vibration element 4 generally is eccentric vibration element 4, which is utilized to drive the whole vibration of head handle 6 and transmitted the vibration to the comb teeth 1, and when the hair brush is in use, the vibration of comb teeth 1 may help massage and relax the scalp on the one hand, and on the other hand, the vibration of comb teeth 1 may help to scatter the hair, which help the hair brush to cross the hair smoothly to effectually hair brush the hair. The vibration of the vibration device may also function to promote blood circulation in the head.

In one embodiment, one of the pluralities of additional function devices is a multi-parameter skin test device, an input end of the multi-parameter skin test device is electrically connected with an output end of the static electricity processing device, and an electrical element in the multi-parameter skin test device consumes electric energy of the processed static electricity.

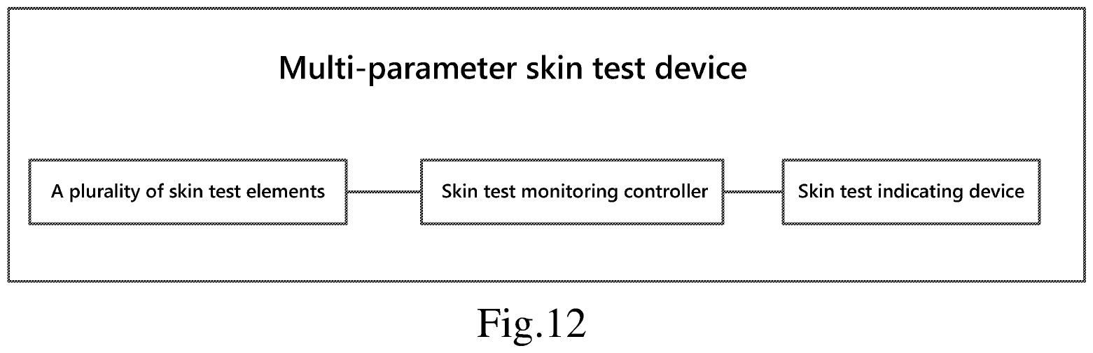

Furthermore, the comb teeth can contact the scalp (or can be used for contacting the skin at other positions) in the using process, the scalp condition can be well monitored by performing skin test on the scalp and better nursed, so one of the pluralities of additional function devices is a multi-parameter skin test device; as shown in FIG. 12, the multi-parameter skin test device comprises several skin test elements, a skin test monitoring controller, and a skin test indicating device; and the skin test elements, the skin test monitoring controller and the skin test indicating device are electrically connected in sequence. The electrical elements in the multi-parameter skin test device comprise a number of skin test components, a skin test monitoring controller, and a skin test indicating device. The skin test monitoring controller is electrically connected with the output end of the static electricity processing device, and the processed static electricity output by the static electricity processing device provides electric energy for the skin test monitoring controller so as to consume the electric energy for the static electricity. The skin test indicating device is electrically connected with the output end of the static electricity processing device, and the processed static electricity output by the static electricity processing device provides electric energy for the skin test indicating device so as to consume the electric energy for the static electricity. Both of these ways may consume electrical energy. The skin test monitoring controller and the skin test indicating device are provided in the hollow cavity.

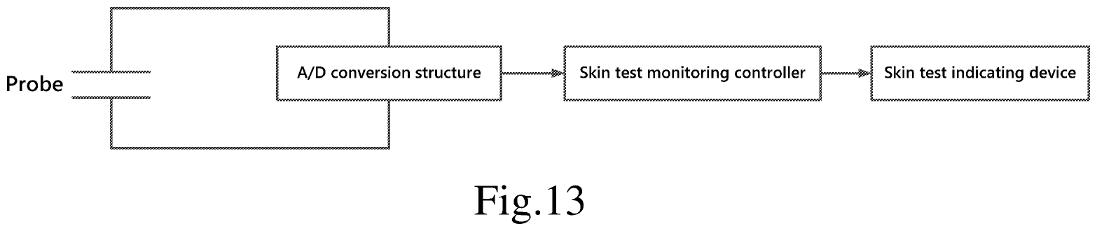

Referring to the drawings, FIG. 13 is a schematic circuit diagram of a multi-parameter skin test device according to an embodiment of the present disclosure.

Specifically, common skin test parameters comprise oil content, moisture content, pH value and the like, and specifically, each skin test parameter needs a different skin test element, for example, the moisture content or the oil content of the skin can be obtained according to an indirect method, specifically, the principle of the indirect method is that the skin electrophysiological characteristics change along with the rise of the moisture content of the skin, and the moisture content is indirectly reflected by measuring the electrophysiological parameters (electrical impedance, electrical conductivity and electrical capacitance) of the skin electrophysiological characteristics; in the moisture content test aiming at the scalp, a capacitance test method is based on the fact that water has very high dielectric constant, the moisture content of the skin cuticle can be reflected by testing the change of the skin capacitance value, and the higher the moisture content of the cuticle is, the higher the capacitance is; correspondingly, the skin test element corresponding to the moisture content parameter is a capacitor, and after an analog signal obtained by the capacitor is converted into a digital signal through a corresponding conversion circuit (such as an RC oscillation circuit), the obtained data is processed through a corresponding skin test monitoring controller, and then the data is indicated through a corresponding skin test indicating device.

Specifically, the skin test element corresponding to any one of the skin test parameters may be selected according to the prior art, and based on feasibility considerations, the size of the relevant structure of any one of the skin test parameters should be considered for reasonable integration onto the hair brush. Because the quantity of comb teeth is large, the multiple skin test elements may be matched with the characteristic that the hair brush has many comb teeth, and the hair brush of this disclosed embodiment can monitor multiple skin parameters to indicate relevant data on skin test indicating device.

In one embodiment, the hair brush further comprises a display screen, and at least one additional function device of the plurality of additional function devices is electrically connected with the display screen so as to show the content required to be displayed by the additional function device through the display screen.

Specifically, the additional function device mainly relates to an additional function module, and therefore, in order to facilitate observation of the operation state of the additional function device and display of relevant data by the additional function device, the hair brush further comprises a display screen 20, and at least one additional function device of the plurality of additional function devices is electrically connected with the display screen 20, so that the display screen 20 shows the content required to be displayed by the additional function device.

Further, considering that under the condition of no static electricity power supply or insufficient static electricity power supply, in order to ensure the work of the additional function device, the hair brush further comprises an auxiliary power supply device; the auxiliary power supply device comprises a charging module and an electric storage module 23, and the charging module is electrically connected with a charging end of the electric storage module 23; the charging module has a charging port 18 exposed at the surface of the body, and at least one of the plurality of additional function devices is electrically connected to an output terminal of the electric storage module 23.

Specifically, the electric storage module 23 essentially has the same property as the static electricity storage module, and therefore, in practical applications, the electric storage module 23 and the static electricity storage module can be the same module, so as to simplify the composition and structure of the hair brush.

Specifically, in order to effectively conduct static electricity, in the embodiment of the present disclosure, the comb teeth 1 are made of a flexible conductor material, and the comb teeth 1 can serve as a static electricity collecting module and are electrically connected (contacted) with the static electricity input end.

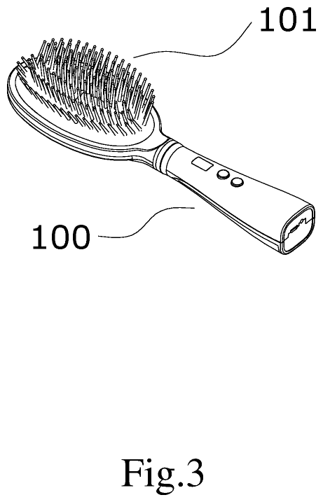

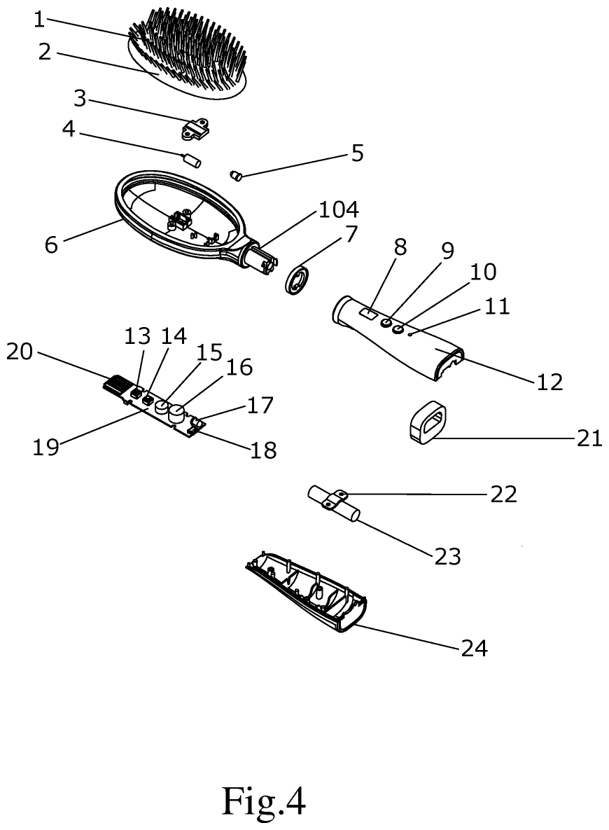

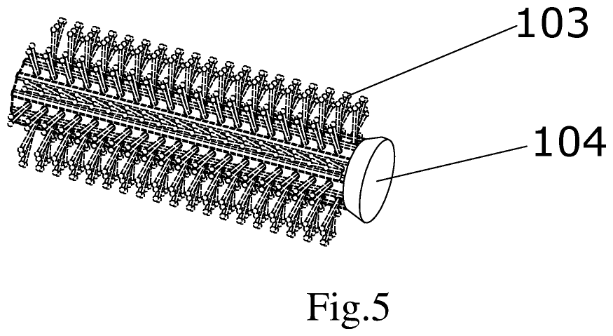

FIG. 3 is a three-dimensional structure schematic diagram of a hair brush according to an embodiment of the disclosure; FIG. 4 is a schematic diagram of an exploded structure of a hair brush according to an embodiment of the present disclosure; FIG. 5 is a three-dimensional structure schematic diagram of a hand holder of a curling hair brush according to an embodiment of the present disclosure.

Specifically, the embodiment of the disclosure provides a hair brush, which comprises a body 100, a comb teeth assembly 101, an active static electricity elimination device and a plurality of additional function devices; the body 100 is a structure for fixing and supporting the hair brush, the comb teeth assembly is a component structure associated with the comb teeth 1, and the active static electricity elimination device and the plurality of additional function devices are structural components for enabling the hair brush to generate specific functions.

Specifically, the body 100 comprises a hand holder and a head handle 6, wherein the hand holder is a portion at the side where a user holds the hand holder, and the head handle 6 is a portion at the side where the comb teeth assembly is provided. It should be noted that, according to different types of hair brushs, the structure of the head handle 6 and the structure of the comb teeth 1 in the comb teeth assembly 101 may have a certain difference, and in the air bag hair brush (the structure shown in FIGS. 3 and 4), the comb teeth 1 are provided on one side of the head handle 6; while in a curling hair brush (the configuration shown in FIG. 5), the teeth are circumferentially provided on the side of the head handle 6. The hair brush structure of the embodiment of the present disclosure is described by taking an air bag hair brush as an example, and structural changes of other structures can be adaptively performed according to the disclosure of the embodiment of the present disclosure.

Accordingly, in order to accommodate the active static electricity elimination device and several additional function devices, the body 100 has a hollow cavity comprising a head handle inner cavity at the side of the head handle 6 and a hand holder inner cavity at the side of the hand holder, corresponding to the zone division of the body 100.

Specifically, the comb teeth assembly 101 comprises a plurality of comb teeth 1, and the comb teeth assembly 101 is provided on the head handle 6; the comb teeth 1 are one of the necessary technical features for realizing the function of the hair brush, and therefore, the comb teeth assembly 101 has to comprise at least the comb teeth 1.

Basically, the main point of disclosure of the hair brush of the embodiment of the present disclosure is that the active static electricity elimination device is provided inside the hair brush, that is, the active static electricity elimination device is provided inside the hollow cavity.

As shown in FIG. 4, the solid structure of the hair brush of the present embodiment is: the body 100 comprises a hand holder and a head handle 6, the hand holder is formed by assembling a hand holder front cover 12 and a hand holder rear cover 24, the hand holder can be assembled by means of buckles and the like, a hand holder inner cavity is formed between the hand holder front cover 12 and the hand holder rear cover 24, a PCB 19 is fixed in the hand holder inner cavity, a display screen 20, a vibration control button 13, a light-emitting control button 14, a sound acquisition element 15, a buzzer 16, a charging indicating lamp 17, a charging port 18 and other solid structures are provided on the PCB 19 with related control circuits provided on the PCB, and correspondingly, the hand holder front cover 12 is provided with a light-emitting control hole 10, a sound source input hole 11, a display hole 8 and a vibration control hole 9 so that the corresponding structures can be exposed on the cover; the electric storage module 23 is fixed on the hand holder rear cover 24 through a storage battery pressing block 22; the head handle 6 is connected to the hand holder through a connecting structure, and the head handle 6 is in contact with the hand holder through a middle ring 7; the light-emitting source 5 is fixed on the head handle 6, and the vibration element 4 is fixed on the head handle 6 through a vibration mounting 3; the rubber sheet 2 wraps the open end of the head handle 6, and the rubber sheet 2 is provided with a plurality of comb teeth 1.

Further, the comb teeth assembly 101 further comprises a rubber sheet 2, and the plurality of comb teeth 1 are provided on the rubber sheet 2; specifically, there are two embodiments of the rubber sheet 2 according to the structure of the head handle 6.

Specifically, the structure of the head handle 6 is mainly related to the shape and function of the hair brush, the common hair brush structure comprises an air bag hair brush (the structure shown in FIGS. 3 and 4) and a curling hair brush (the structure shown in FIG. 5), correspondingly, for the air bag hair brush, one end of the head handle 6 is an open end, the rubber sheet 2 is wrapped on the edge of the open end of the head handle 6 and is used for sealing the open end, and the head handle inner cavity is provided between the head handle 6 and the rubber sheet 2; for the curling hair brush, the head handle 6 is of a cylindrical structure, the head handle inner cavity is provided inside the head handle 6, and the rubber sheet 2 is at least wrapped on the inner side surface of the head handle 6.

Specifically, the rubber sheet 2 has a soft characteristic, and in actual use, the rubber sheet 2 can be deformed to a certain extent to improve the comfort of use. It should be particularly noted that, in the air bag hair brush, since the inner side of the rubber sheet 2 is the head handle inner cavity, the rubber sheet 2 can generate certain concave deformation besides the deformation of the material of the rubber sheet 2, so that the comb teeth 1 can be better attached to the scalp, and better use comfort can be provided.

The rubber sheet 2 is configured to be in contact with hair or the like, and the material of the rubber sheet 2 is a flexible conductive material in order to improve the static electricity collection effect. The rubber sheet 2 may be used as a static electricity collecting module to be electrically connected (contacted) with the static electricity input end so as to improve the static electricity collecting effect.

In addition, correspondingly, if the additional function device needs external control, the additional function device may be controlled externally by providing an entity button on the hand holder or by means of sound-controlled and the like, and the embodiment of the disclosure is not necessarily explained.

Further, in consideration of the use hand feeling of the hair brush and the capability of enabling the hair brush to be set upright, the hair brush further comprises a counter-weight module 21; the counter-weight module 21 is provided at the end of the body 100 away from the comb teeth assembly, for example at the hand holder. According to the arrangement form of the additional function device, the counter-weight module 21 adjusts the center of gravity of the hair brush, which makes the hair brush has better use hand feeling. In addition, the hand holder is provided with the counter-weight module 21, so that the gravity center of the hand holder falls on the hand holder; when the end surface of the hand holder is provided to be a plane on which the hair brush may be placed, the hair brush can be set upright, and basically, the hair brush can be more conveniently stored if it is set upright; in addition, the vertical placement of the hair brush can enable components such as a display screen, a control button and the like on the hand holder to face a user for the user to use; further, additional function devices such as a light-emitting device on the hair brush can be used by the user when the hair brush is set upright.

Further, for the convenience of assembly, the hand holder and the head handle 6 are of separate structures, and the hand holder and the head handle 6 are connected by a connecting structure 104. In particular, the connecting structure 104 is a relevant structure for providing connection between the head handle 6 and the hand holder, and in particular, the same connecting structure can be used for head handles with different structures, so as to improve the applicability of the hand holder and facilitate the replacement of the head handle 6 by a user. Wherein, the head handle 6 and the hand holder has to be electrically connected besides the physical connection relation; basically, the circuits inside the head handle 6 and the hand holder may be connected by using wires and the like, and further, the connecting structure disclosed in the embodiment of the present disclosure may also comprise an electrical connection besides a physical connection, where the electrical connection may be a contact connection and the like. Specifically, the connecting structure can be determined according to the actual implementation structure, in order to avoid rigid contact between the hand holder and the head handle 6, optionally, a middle ring 7 made of soft material can be provided at the contact position of the hand holder and the head handle 6, so as to avoid direct rigid contact between the hand holder and the head handle 6.

In summary, the embodiment of the present disclosure provides a hair brush, in which an active static electricity elimination device is provided, so that the hair brush may be used in a wider application range than that with a passive static electricity elimination device, and the hair brush of this disclosure has good practicability; the active static electricity elimination device may collect static electricity for power to drive an additional function device, but not directly dissipate the static electricity, so that energy may be fully utilized, avoided being waste, which realize internal supply of the energy; through providing various additional function devices, structures such as comb teeth 1 may be illuminated, the temperature and humidity around the comb teeth 1 may be monitored, and the comb teeth may be driven to vibrate in a vibration transmission mode, so as to better meet the use requirements of users; in addition, through providing auxiliary power supply devices, the hair brush may ensure the use of the additional function devices under the condition of no static electricity supply, which may ensure the additional function device in the hair brush to work stably.

The hair brush provided by the embodiment of the present disclosure is described in detail above, and the principle and the implementation manner of the present disclosure are explained by providing specific embodiments herein, and the description of the above embodiments is only used to help understanding the method and the core idea of the present disclosure; meanwhile, for a person skilled in the art, the schemes may be derived according to the idea of the present disclosure, the specific embodiments and the application range, and in conclusion, the content of the present specification should not be construed as a limitation of the present disclosure.

What is claimed:

1. A hair brush, wherein, comprising a body, a comb teeth assembly and an active static electricity elimination device;
the body is provided with a hollow cavity;
the comb teeth assembly comprises a plurality of comb teeth and the comb teeth assembly is provided on the body;
the active static electricity elimination device is set in the hollow cavity;
the active static electricity elimination device comprises a static electricity processing device and a plurality of additional function devices;
the input end of the static electricity processing device is electrically connected with the comb teeth assembly, the output end of the static electricity processing device is electrically connected with at least one of the pluralities of additional function devices, and the static electricity processing device processes the static electricity input by the comb teeth assembly and outputs the processed static electricity to the additional function devices;
and the additional function devices consumes electric energy of the processed static electricity.

2. The hair brush according to claim 1, wherein, the static electricity processing device comprises a static electricity conversion module, an input end of the static electricity conversion module is electrically connected with the comb teeth assembly, an output end of the static electricity conversion module is electrically connected with the at least one additional function device, and the static electricity conversion module converts the static electricity and outputs the processed static electricity to the additional function device.

3. The hair brush according to claim 2, wherein, the static electricity conversion module comprises a high voltage suppression unit and a voltage stabilization output unit, an input end of the high voltage suppression unit is electrically connected with the comb teeth assembly, an output end of the high voltage suppression unit is electrically connected with an input end of the voltage stabilization output unit, and an output end of the voltage stabilization output unit is electrically connected with the additional function device;
the high voltage suppression unit performs voltage suppression on the instantaneous high voltage of the static electricity input by the comb teeth assembly and then outputs the static electricity to the voltage stabilization output unit, and the voltage stabilization output unit performs voltage stabilization on the static electricity after voltage suppression and then inputs the static electricity to the additional function device.

4. The hair brush according to claim 2, wherein, the static electricity processing device further comprises a static electricity storage module, an input end of the static electricity storage module is connected with an output end of the static electricity conversion module, an output end of the static electricity storage module is electrically connected with at least one additional function device, the static electricity conversion module converts the static electricity and outputs the processed static electricity to the static electricity storage module, and the static electricity storage module stores the processed static electricity and outputs the stored static electricity to the additional function device.

5. The hair brush according to claim 1, wherein, one of the pluralities of additional function devices is a light-emitting device, an input end of the light-emitting device is electrically connected with an output end of the static electricity processing device, and the light-emitting device converts the electric energy of the processed static electricity into light energy and then consumes the light energy.

6. The hair brush according to claim 5, wherein, the light-emitting device comprises a light-emitting controller and a light-emitting source, the light-emitting controller and the light-emitting source being provided in the hollow cavity, the light-emitting source being controlled based on the light-emitting controller;
the light-emitting light source is electrically connected with the output end of the static electricity processing device, and the light-emitting light source converts the electric energy of the processed static electricity into light energy and then consumes the light energy;
at least one comb tooth of the plurality of comb teeth is made of a first light-transmitting material and is communicated into the inner cavity of the body, and/or the body is made of a second light-transmitting material.

7. The hair brush according to claim 6, wherein, the first light-transmitting material is a transparent material containing a light diffusing agent.

8. The hair brush according to claim 7, wherein, the volume ratio of the light diffusing agent in the transparent material is 0.5 to 1%.

9. The hair brush according to claim 7, wherein, the transparent material is also mixed with a light anti-reflection agent.

10. The hair brush according to claim 9, wherein, the volume ratio of the light anti-reflection agent in the transparent material is 2.5 to 3.5%.

11. The hair brush according to claim 6, wherein, the surface of the body is further provided with a pattern layer provided that the material of the body is a second light-transmitting material.

12. The hair brush according to claim 6, wherein, at least part of the cavity wall of the body are covered with a light reflecting film.

13. The hair brush according to claim 6, wherein, the light-emitting device further comprises a light-emitting control button exposed on the surface of the body;
the light-emitting control button is electrically connected with the light-emitting controller.

14. The hair brush according to claim 6, wherein, the light-emitting device further comprises a sound acquisition element, the light-emitting controller is a sound-controlled controller;
the sound-control controller is electrically connected with the sound acquisition element.

15. The hair brush according to claim 1, wherein, one of the pluralities of additional function devices is a temperature sensing device, an input end of the temperature sensing device is electrically connected with an output end of the static electricity processing device, and an electrical element in the temperature sensing device consumes electric energy of the processed static electricity.

16. The hair brush according to claim 1, wherein, one of the pluralities of additional function devices is a humidity sensing device, an input end of the humidity sensing device is electrically connected with an output end of the static electricity processing device, and an electrical element in the humidity sensing device consumes electric energy of the processed static electricity.

17. The hair brush according to claim 1, wherein, one of the pluralities of additional function devices is a vibration device, an input end of the vibration device is electrically connected with an output end of the static electricity processing device, and an electrical element in the vibration device consumes electric energy of the processed static electricity.

18. The hair brush according to claim 1, wherein, one of the pluralities of additional function devices is a multi-parameter skin test device, an input end of the multi-parameter skin test device is electrically connected with an output end of the static electricity processing device, and an electrical element in the multi-parameter skin test device consumes electric energy of the processed static electricity.

19. The hair brush according to claim 1, wherein, the hair brush further comprises a display screen, and at least one additional function device in the pluralities of additional function devices is electrically connected with the display screen so as to display the contents required to be displayed by the additional function device through the display screen.

20. The hair brush according to claim 1, wherein, the teeth are made of a flexible conductive material.

21. The hair brush according to claim 1, wherein, the comb teeth assembly further comprises a rubber sheet, and the pluralities of comb teeth are provided on the rubber sheet;
one end of the body is an open end, the rubber sheet is wrapped on the edge of the open end of the body and closes the open end, the hollow cavity is formed by the rubber sheet wrapping around the edge of the open end of the body, or the body is of a cylindrical structure, the hollow cavity is provided in the body, and at least part of the rubber sheet is wrapped on the side surface of the inner part of the body;
the rubber sheet is made of a flexible material, and when the hair brush is in a stowed mode, the rubber sheet is sunken into the hollow cavity, so that a notch is formed between the rubber sheet and the open end to accommodate all the comb teeth and prevent the end of the comb teeth which is far away from the rubber sheet from extending out of the open end; when the hair brush is in a deployed mode, the rubber sheet bulges outwards from the open end, so that the rubber sheet and the comb teeth are completely exposed outside the open end of the body.

22. The hair brush according to claim 21, wherein, the body comprises an upper housing and a lower housing, one end of the lower housing is the open end of the body, the other end of the lower housing is detachably connected with one end of the upper housing, the other end of the upper housing is provided with the top cover, the top cover moves up and down along the direction perpendicular to the edge of the upper housing so as to make the top cover contact rubber sheet and exert a force on the rubber sheet in order to push the sunken rubber sheet to bulges from the edge of the open end under exogenic action.

23. The hair brush according to claim 1, wherein, the comb teeth assembly further comprises a rubber sheet, and the plurality of comb teeth are provided on the rubber sheet;
the body comprises a hand holder and a head handle, and the hollow cavity comprises a head handle inner cavity provided at the side of the head handle and a hand holder inner cavity provided at the side of the hand holder; one end of the head handle is an open end, the rubber sheet is wrapped on the edge of the open end of the head handle and closes the open end, and the head handle inner cavity is provided between the head handle and the rubber sheet; or the head handle is of a cylindrical structure, the head handle inner cavity is provided in the head handle, and at least part of the rubber sheet is wrapped on the inner side surface of the head handle.

24. The hair brush according to claim 23, wherein, the hand holder and the head handle are separated structures from each other, and the hand holder and the head handle are connected through a connecting structure.

25. The hair brush according to claim 21, wherein, the rubber sheet is made of a flexible conductor material.

26. The hair brush according to claim 1, wherein, further comprising a counter-weight module;
the counter-weight module is provided at the end of the body which is far away from the comb teeth assembly.
